(19) United States
(12) Patent Application Publication
(10) Pub. No.: US 2007/0209009 A1
(43) Pub. Date: Sep. 6, 2007

(54) Display with settings changed according to user's ID and method thereof

(75) Inventor: Chih-Li Huang, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Inventec Corporation, Taipei (TW)

(21) Appl. No.: 11/366,063

(22) Filed: Mar. 2, 2006

(51) Int. Cl. G06F 17/00; G06F 3/00

(52) U.S. Cl. 715/745

(57) ABSTRACT

A display with settings changed according to a user's ID and a method thereof, suitable for being applied to a display are provided. After the display has been powered on, the corresponding display settings are stored according to the user's ID. After inputting a user's ID, having been compared by a recognizing device, the display settings are updated to the state set by the user.

### BACKGROUND OF THE INVENTION

1. Field of Invention

The present invention relates to a display with settings changed according to a user's ID and a method thereof, more particularly, to one suitable for being applied to a display, for updating the display settings to settings set by a user according to the user's ID.

2. Related Art

The audio-visual display apparatus is the most direct sensory interface provided between man and electronics/information related products such as TVs, computers, and other electronic information products. That is, the audio-visual display apparatus acts as an output apparatus for images and text picture signals.

Until now, TV has been one of the audio-visual devices most widely used among common families. Especially in the era of information explosion, TV has been provided with many additional functions as well, e.g., certain relatively advanced TVs have a picture in picture function, an instruction to obtain the largest information at a certain time, or selection among multiple languages, etc., which are all the result of advanced technology. Only with the playing function of TV to transmit signals in real-time can the user achieve a sense of being personally at the scene both in vision and hearing, no matter whether he/she is watching or listening.

As for the conventional art, it is shown in FIG. 1, a systematic block diagram of the conventional multimedia display, which includes a data retrieve module 11, an editor 13, a transmission interface 14, a playing system 15, and a user interface 12. When the user executes a playing instruction through the user interface 12, the data retrieve module 11 retrieves a multimedia data 10, and sends it to the editor 13, and then the data is transferred to the playing system 15 for being playing through the transmission interface 14.

Referring to FIG. 2, it is a flow chart of the playing steps according to the 10 conventional art. First, the power is turned on. Then, the user selects a source of a multimedia frequency. Then, the multimedia data is retrieved and sent to the playing system.

The above steps are the playing flow of the conventional art, i.e., the common flow of powering on. After the TV is powered on, the settings of the TV itself are always left as those of the last user. Since each person has different use habits, the familiar chromas of the screen may also be different, and the current user may not be accustomed to the settings left by the previous user, so after powering on, it is necessary to take some time to adjust the settings to the state one likes. However, this repeated modification and adjustment is not only time-consuming, but also fairly impractical for humanity, since nowadays speed is a concern and personalization is promoted.

### SUMMARY OF THE INVENTION

In view of the above, an object of present invention is to provide a recognition method for changing display settings according to a user's ID, wherein by recognizing the user's ID, the display settings can be updated to the state preset by the user, thereby solving the problems of the prior art.

Thus, in order to achieve the above mentioned object, the recognition method of changing display settings according to a user's ID according to the present invention, suitable for being applied to a display, includes: a memory, an input module, a recognizing device, and a playing interface. The recognition method of changing display settings according to a user's ID includes the following steps.

After the display is powered on, first, a menu will be displayed on the screen, and confirmation of the user's ID is requested. The user then inputs a user ID via the input module, and subsequently the stored ID data is retrieved from the database, and the two data are compared by the recognizing device.

With the comparison result of the recognizing device, when the ID data of the database matches the input user's ID data, the corresponding display settings can be retrieved according to the user's ID data.

With the retrieved corresponding display settings, the display setting values can be updated to match the display settings relative to the current user's ID.

Therefore, in the recognition method of changing the display settings according to a user's ID provided in the present invention, a comparison and determination are carried out according to the input user ID, such that the display settings can be updated to match the display setting values set by the user previously. Further, since each set of settings has been stored according to the present invention, the user does not need to repeatedly set the display settings each time after the display is powered on. The current user can be known by way of memorized setting, and the best setting manner of the user can be shown automatically by using the previous settings, thereby achieving audio-visual enjoyment with personalized settings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is a systematic block diagram of the conventional multimedia display;

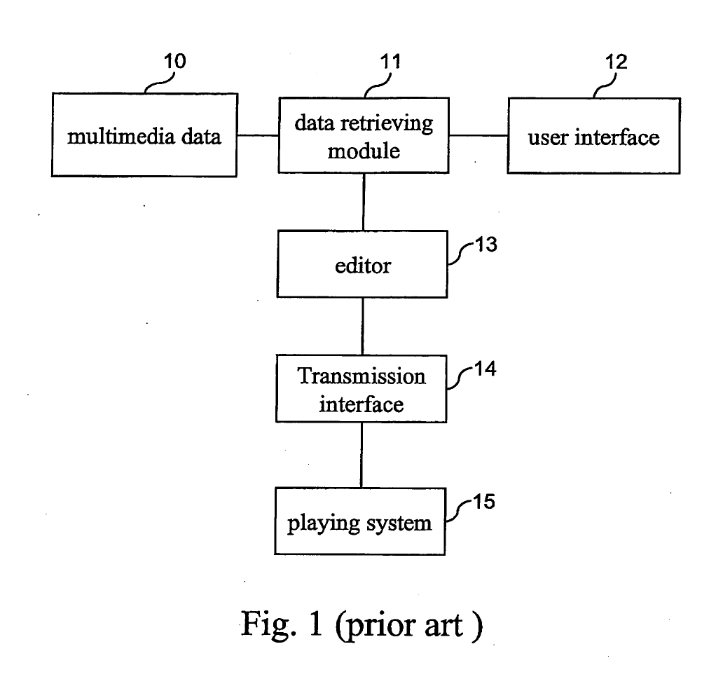

FIG. 2 is a recognition method of changing the display settings according to a user's ID according to the present invention; and

FIG. 3 is a systematic block diagram of the display with settings being changed according to a user's ID according to the present invention.

### DETAILED DESCRIPTION OF THE INVENTION

In order to make the objects, structures, features, and functions of the present invention more comprehensible, it will be described below in detail with the detailed description. The illustration of the summary of the invention above and the detailed description hereafter are used to demonstrate and explain the principle of the present invention, and to provide the further explanation of the claims of the present invention.

In the recognition method of changing the display settings according to a user's ID according to the present invention, the input user ID and the ID data of the database are compared by the recognizing device 210, such that the corresponding display settings are carried out to match the setting favor of the user.

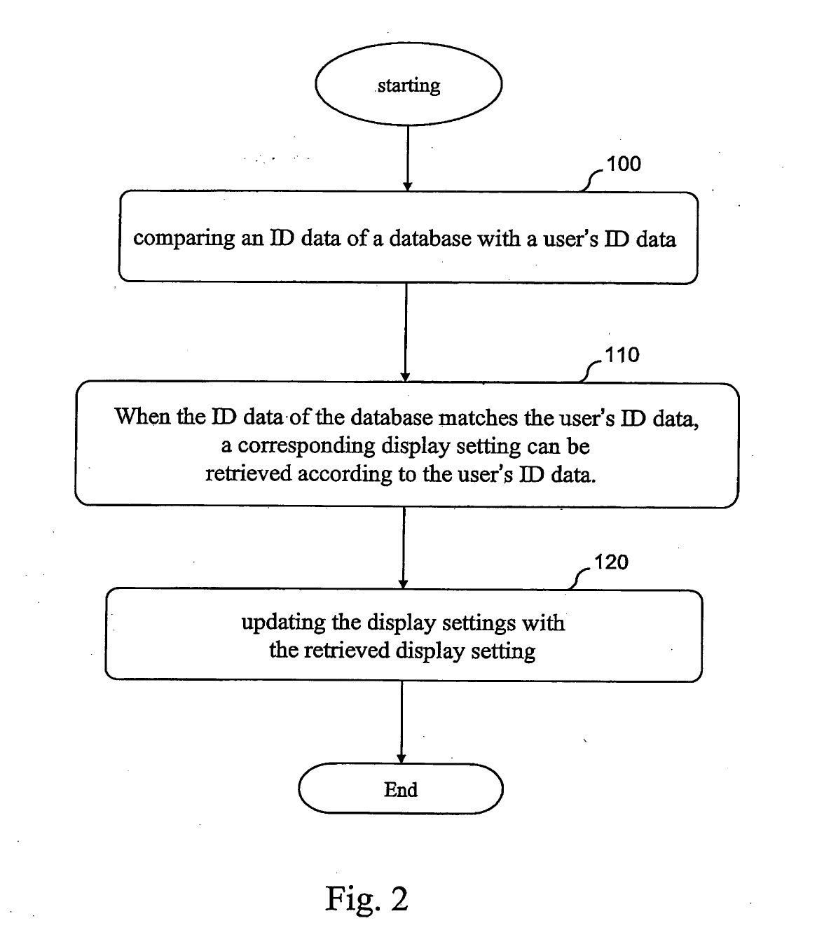

Therefore, referring to FIG. 2, it is a flow chart of the steps of the present invention. The recognition method of changing the display settings according to a user's ID disclosed in the invention, suitable for being applied to the display, includes the following steps.

After the display being powered on, first, a menu will be displayed on the screen, and the confirmation of the user's ID is requested. The user then inputs a user ID via the input module 200, and subsequently the stored ID data is retrieved from the database, and the two data are compared by the recognizing device 210. (Step 100)

Then, with the comparison of the recognizing device 210, when the ID data of the database matches the input user ID data, the corresponding display setting 231 can be retrieved according to the user's ID. (Step 110) Finally, with the retrieved corresponding display settings 231, the display setting value can be updated to match the display settings 231 relative to the current user's ID. (Step 120)

For example, through the method of the present invention, the user turns on the power, and then simply inputs the user's ID data, so that the user can be recognized by the display. Then, the display can be updated by using the display settings 231 set previously, to match the personalized settings, and automatically display the setting manner that the current user prefers, such as, the selection of channels, the volume, the broadcasting of speech, the color, the brightness contrast, and other settings.

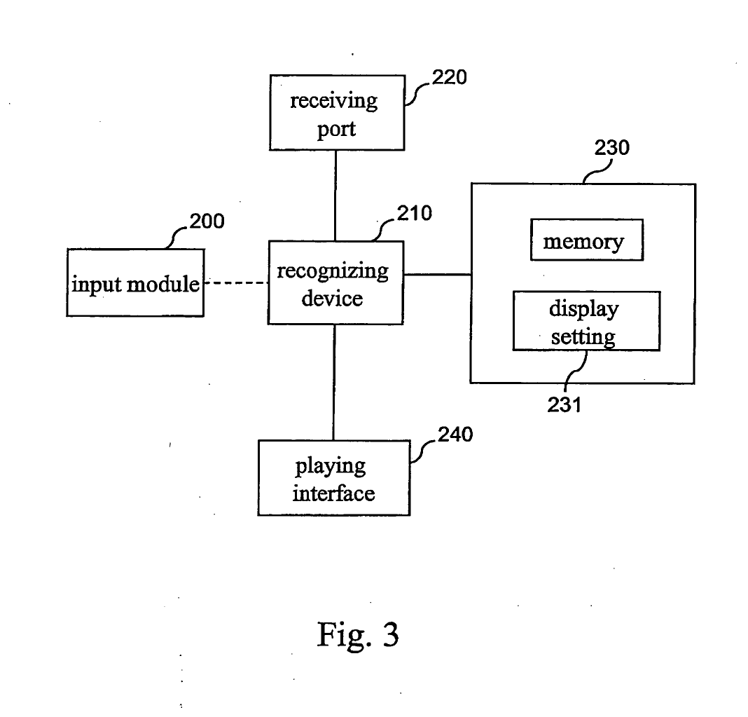

Again, referring to FIG. 3, it is a systematic block diagram of the display with the settings changed according to a user's ID according to the present invention. It can be applied to displays, such as, cathode ray tube (CRT) displays, liquid crystal displays (LCDs), and Plasma Display Panels (PDPs), etc., which includes.

A memory 230 is used for storing a plurality of display settings 231 set by the user according to the different user's ID data, with the function of repeatedly editing. This memory 230 can be an Electrically Erasable Programmable Read Only Memory (EEPROM), a Flash Memory, a Memory Card, and the like. And according to the current specification, the Memory Card can be classified into EEPROM, Flash Memory, Compact Flash Card (CF Card), Secure Digital Card (SD Card), Smart Media Card (SMC Card), Multi-media Card (MMC Card), Memory Stick Card (MS Card), and other different selections.

An input module 200 is used for inputting the user's ID data. The input module 200 can be respectively the operating buttons of the panel of the display, the remote controller of the display, the writing board, the external keyboard, the video camera, the microphone, the fingerprint recognizer, or the sound control recognizer, and the like. However, the user ID data that is used for recognition is a group of text data, sound data, images, fingerprints, or a group of numeral symbols, etc.

A recognizing device 210 is used for retrieving the user ID data of the memory 230 and making a comparison between the user ID data of the memory 230 and the current user ID data. When the comparison result shows that they are matched, the corresponding display settings 231 can be obtained from the memory 230.

A playing interface 240 has the function of playing the multimedia data, wherein, according to the comparison result of the recognizing device 210, the setting of the playing interface 240 can be updated to match the corresponding display settings 231, thereby matching the setting preferences of the user.

For example, when the user uses the display for the first time, since the setting related to the user cannot be found in the memory 230, the display now outputs the multimedia data received by the receiving port 220 with the previously set values. As soon as entering the playing picture, the using settings of the display is adjusted, such as, the selection of channels, the volume, the broadcasting of speech, the color, and the brightness contrast, etc. And a group of numeral symbols must be set, for example, 123456, indicating the symbol of the current user's ID. When the user completes the display settings he prefers, the picture can be switched back to the menu and the user ID data 123456 should be input again. Now, memory 230 will store a set of display settings with the corresponding user's ID symbol as 123456. Then, after turning on the power next time, the user only needs to input 123456, and all of the user data stored in the memory 230 will be compared by the recognizing device 210. Then a display setting 231 can be searched in the memory 230, with the user's ID symbol as 123456, such that the updating process will be carried out for making the setting value of the playing interface 240 match the display setting 231 whose user ID symbol is 123456 to satisfy the personalized audio-visual enjoyment. Further, when the user wants to change the display setting 231, after the settings have been adjusted, the playing picture is switched back to the menu, and the user ID symbol 123456 should be input again. Now, the memory will store another display setting 231 with the corresponding user ID symbol as 123456. When the display is powered on next time, the new display setting 231 can be used immediately according to the above steps.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A recognition method of changing display settings according to a user's ID, suitable for being applied to a display, comprising the following steps:
comparing an ID data of a database with a user's ID data,
when the ID data of the database matches the user's ID data, a corresponding display setting can be retrieved according to the user's ID data; and
updating the display setting with the retrieved display setting.

2. The recognition method as claimed in claim 1, wherein the user's ID data is set and input by the user via an input module.

3. The recognition method as claimed in claim 2, wherein the input module is disposed in the display.

4. The recognition method as claimed in claim 2, wherein the input module is a remote controller disposed in the display.

5. The recognition method as claimed in claim 1, wherein the database and the preset state are stored in a memory.

6. The recognition method as claimed in claim 4, wherein the memory is selected from a group consisting of Electrically Erasable Programmable Read Only Memory (EEPROM), Flash Memory, and Memory Card.

7. A display with settings changed according to a user's ID, comprising:
a memory, for storing a display setting set by the user according to the user's ID;
an input module, for inputting a user's ID data;
a recognizing device, for retrieving the comparison result between the user ID data of the memory and the user's ID data, so as to obtain the corresponding display setting; and
a playing interface, for playing a multimedia data;
wherein, the setting of the playing interface can be updated to match the corresponding display setting according to the comparison result of the recognizing device.

8. The display as claimed in claim 7, wherein the input module is disposed in the display.

9. The display as claimed in claim 7, wherein the input module is a remote controller disposed in the display.

10. The display as claimed in claim 7, wherein the memory is selected from a group consisting of Electrically Erasable Programmable Read Only Memory (EEPROM), Flash Memory, and Memory Card.
